(19) United States
(12) Patent Application Publication
(10) Pub. No.: US 2005/0168452 A1
(43) Pub. Date: Aug. 4, 2005

(54) Operating apparatus

(75) Inventor: Minoru Sunadome, Kawagoe (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/049,895

(22) Filed: Feb. 4, 2005

(30) Foreign Application Priority Data
Feb. 4, 2004 (JP) 2004-028616

(51) Int. Cl. G09G 5/00

(52) U.S. Cl. 345/184

(57) ABSTRACT

An operating apparatus is provided with an operating axis, a regulating member and a switching mechanism. The operating axis is supported to swing freely. The operating axis is detected by a detecting switch when a one end portion of the operating axis contacts to the detecting switch. The regulating member makes the one end portion to contact any detecting switch. The switching mechanism is capable of switching a regulating state in which the regulating member makes the one end portion to contact to any detecting switch and a non-regulating state in which the operating axis is allowed to be positioned between the detecting switches adjacent to each other.

### BACKGROUND OF THE INVENTION

1. Field of the Invention

The present invention relates to an operating apparatus used for operating various kinds of electronic devices, such as navigation apparatus and game apparatus.

2. Description of Related Art

The instrument panel of a car as a movable body is provided, for example, with a navigation apparatus as an electronic device (see Japanese Published publication. No. H10-301485). Navigation apparatus comprises an apparatus main body of a box shape which processes the whole navigation system based on GPS (Global Positioning System) positioning data, a display which is attached to the apparatus main body and displays map data etc., and an operating apparatus for inputting various kinds of information into the apparatus main body.

The display displays map data. Moreover, when inputting a destination etc., the display displays characters and numbers arranged lattice-like, such as “hiragana”. Operating apparatus is used in order to move the displayed area of the map data on the display toward the desired direction. Moreover, the operating apparatus is used to choose a desired character and a desired number from various kinds of characters and numbers which are on the display in order to input the destination etc. into the apparatus main body, and used to input it into the apparatus main body.

Operating apparatus comprises a box-shape main body, an operating axis which moves freely to many directions centered at the one end portion in the main body, and a detecting switch as a plurality of detecting means received in the main body. The detecting switches, for example eight switches, are provided at equal intervals along the circumferential direction centered at the one end portion of the operating axis.

The detecting switch detects the contact of the one end portion of the operating axis which swings to the main body. The one end portion of the operating axis enters into the detecting area which has a sector form in the circle centered at the one end portion of the operating axis and contacts to the detecting switch. A plurality of detecting switches are arranged without clearance and overlapping.

Moreover, the detecting switch detects that when the one end portion of the operating axis contacts to the detecting switch and the other end portion of the operating axis falls inwardly the detecting area, the operating axis moves to the main body portion.

Moreover, the aforementioned operating apparatus detects the direction to which the operating axis falls down in the main body portion, by a contact of the one end portion of the operating axis with any detecting switch among a plurality of the detecting switches.

When the operating axis swings to the main body portion at the operating apparatus, any detecting switch among the plurality of detecting switches detects the contact of the one end portion of the operating axis. Then, the operating apparatus outputs the information which shows the direction where the detected switch, i.e., the operating axis falls, to the apparatus main body. Then, the car navigation moves the display area of the map data on the display along the direction where the operating axis falls.

When displaying map data on the display, the car navigation moves the display area of the map data on the display by swinging the operating axis of the operating apparatus to the main body portion. Moreover, when displaying the character or number on the display, the car navigation moves the cursor on the character or number on the display by swinging the operating axis of the operating apparatus to the main body portion. For example, when eight detecting switches are provided, the car navigation moves the map data or cursor to the total eight directions of upper, lower, left, right and left-upper direction etc.

In the operating apparatus, the operating axis is fallen down toward between adjacent detecting switches and the one end portion thereof contacts one of the detecting switches adjacent to each other.

For this reason, when the operating axis is fallen down toward between the detecting switches adjacent to each other, there was a detection of the detecting switch which user do not mind.

When moving the displayed area of map data, it is desirable for the operating apparatus of the conventional car navigation to swing the operating axis without providing a user any feelings of moderation and click. For this reason, when moving the displayed area of map data, the operating axis is fallen down toward between the detecting switches adjacent to each other, even if the detecting switch, which user do not intend, detects, there is no problem practically and the displayed area of the map data on the display can be moved.

Moreover, when displaying characters and numbers on the display and inputting the information, which consists of these characters and numbers, into the apparatus main body, it is desirable to position the cursor easily and certainly on the desired characters and numbers. For this reason, it is not desirable that the operating axis is fallen down toward between the detecting switches adjacent to each other and the one end portion of the operating axis contacts to the detecting switch which user do not intend.

Therefore, the operating apparatus of car navigation is preferably capable of switching a regulating state in which the operating axis is regulated to be positioned between the detecting means adjacent to each other, such as a plurality of detecting switches, and an permitting state in which the operating axis is permitted to be positioned between the detecting means adjacent to each other, such as a plurality of detecting switches.

When inputting characters and numbers, the operating apparatus will be in the regulating state in which the operating axis is regulated to be positioned between the detecting means adjacent to each other, such as a plurality of detecting switches. When moving the displayed area of map data, the operating apparatus will be in the permitting state in which the operating axis is permitted to be positioned between the detecting means adjacent to each other, such as a plurality of the detecting switches.

### SUMMARY OF THE INVENTION

The object of the present invention herein is to provide an operating apparatus which is capable of switching a regulating state in which the operating axis is regulated to be positioned between the detecting means adjacent to each other among the detecting means to detect the operating axis and a permitting state in which the operating axis is permitted to be positioned between the detecting means adjacent to each other.

For achieving the object, an operating apparatus according to the present invention has an operating axis which swings freely to many directions centered at an one end portion, and detecting switches provided in the circumferential direction centered at the one end portion of the operating axis and detecting the operating axis to swing. The operating apparatus is also provided with a regulating means to regulate the swing direction of the operating axis and a switching mechanism which is capable of switching the regulating state in which the regulating means regulates the swing direction of the operating axis and the non-regulating state in which it does not regulate.

Thereby, the regulating means is capable of switching the regulating state and the non-regulating state by the switching mechanism. This is assuredly able to switch the state in which the operating axis is regulated to position between the detecting switches adjacent to each other and the state in which the operating axis is allowed to position between the detecting switches adjacent to each other.

Preferably, at the regulating state, when the operating axis swings to between the detecting switches adjacent to each other, it is guided to either one of the detecting switches.

Thereby, at the regulating state, when the operating axis swings to between the detecting switches adjacent to each other, it is guided to one of the detecting switches. Therefore, at the regulating state, the operating axis is regulated to be positioned between the detecting switches adjacent to each other.

Preferably, the regulating means is provided with a regulating member having a convex which abuts to the operating axis swung and regulates the swing direction. The switching mechanism is provided with a thin portion and a thick portion which are provided in communication with the operating axis along the longitudinal direction thereof, and a moving means which moves freely at least one of the operating axis and the regulating member to along the longitudinal direction. By the moving means, when the thin portion and the convex portion are positioned it becomes the non-regulating state and when the thick portion and the convex portion are positioned it becomes the regulating state.

Thereby, the regulating means is provided with the regulating member having the convex abutting to the operating axis. The switching mechanism is provided with the thick portion and thin portion provided in the operating axis, and the moving means to move at least one of the operating axis and the regulating member.

The thick portion contacts to the convex portion at the regulating state. Then, at the regulating state, the thick portion contacts to the convex portion so that the operating axis is guided for the thick portion to escape from the convex portion. At the regulating state, the operating axis is assuredly guided into any detecting area R.

At the non-regulating state, at least one of the operating axis and the regulating member is moved from the state that the thick portion contacts with the convex and the thin portion and the convex portion are positioned. Then, at the non-regulating state, the thin portion does not interfere with the convex, the operating axis is positioned between the detecting switches adjacent to each other, and it can be positioned to any detecting switch.

Thus the regulating member is provided with the convex and the operating axis is provided with the thick portion and the thin portion, and at least one of the operating axis and the regulating member is movable by the moving means. This is assuredly able to switch the state in which the operating axis is regulated to be positioned between the detecting switches adjacent to each other and the state in which the operating axis is allowed to be positioned between the detecting switches adjacent to each other.

Preferably, the moving means is provided with the moving member movable along the direction which intersects to the longitudinal direction of the operating axis, a projected pin which is provided in either the regulating member or the moving member projecting from one member to the other, and an insertion bore provided in the other member, into which the projected pin enters, extending to the intersecting direction both to the moving direction of the moving member and the longitudinal direction of the operating axis. The moving member moves and the position of the projected pin inside the insertion bore changes so that the regulating member is moved along the longitudinal direction of the operating axis.

Thereby, the moving mechanism is provided with the projected pin provided in the regulating member and the insertion bore provided in the moving member for the projected pin to enter. The moving mechanism moves the moving member to suitably change the position of the projected pin inside the insertion bore and assuredly move the regulating member along the longitudinal direction of the operating axis. Thus, the operating axis and the regulating member are moved assuredly and relatively.

This is able to switch the state that the thick portion can contact to the convex portion and the state that the thin portion has a clearance to the convex portion. Then, it is able to switch assuredly the regulating state and the non-regulating state.

Preferably, the regulating member is formed with elastic material.

Thereby, since the regulating member is formed with elastic material, when the operating axis contacts to the convex portion at the regulating state, the convex portion is deformed elastically to the direction apart from the center C of the through bore. The elastic resilience of the elastic deformation guides the operating axis to escape from the convex portion. The regulating member assuredly guides the operating axis for the one end portion to enter into either one of the detecting areas R of the detecting switches adjacent to each other.

### BRIEF DESCRIPTION OF THE DRAWINGS

FIG. 1 is a perspective view showing the appearance of a car navigation as electronic apparatus to which the present operating apparatus is attached;

FIG. 2 is a perspective view showing the operating apparatus of the first embodiment of the present invention;

FIG. 3 is a perspective view showing the exploded operating apparatus shown in FIG. 2;

FIG. 4 is a front view of the display of the car navigation shown in FIG. 1;

FIG. 5 is a front view of the operating apparatus shown in FIG. 2;

FIG. 6 is a sectional view along VI-VI line in FIG. 2;

FIG. 7 is a front view showing the relative position of the regulating member, the operating axis and the detecting area of the operating apparatus shown in FIG. 2;

FIG. 8 is a front view showing the knob removed from the operating axis of the operating apparatus shown in FIG. 2;

FIG. 9 is a sectional view along B-B line at the regulating state in FIG. 8;

FIG. 10 is a perspective view showing that the operating axis swings and the thick portion contacts to the convex portion shown in FIG. 9;

FIG. 11 is a sectional view along B-B line at the non-regulating state in FIG. 8;

FIG. 12 is a perspective view showing that the operating axis shown in FIG. 11 swings and the thin portion has a clearance to the convex portion;

FIG. 13 is an illustrative view showing the trajectory of the thick portion and the regulating member in the regulating state shown in FIG. 9;

FIG. 14 is a illustrative view showing the trajectory of the thin portion and the regulating member in the non-regulating state shown in FIG. 11;

FIG. 15 is a front view showing that the operating axis of the operating apparatus shown in FIG. 8 is fallen down to be positioned above the boundary;

FIG. 16 is an illustrative view showing the thick portion of the operating axis and the convex portion of the through bore shown in FIG. 15,

FIG. 17 is an illustrative view showing the thick portion and the convex portion of the through bore of the regulating member when the operating axis moves along the arrow C1 from the state shown in FIG. 15;

FIG. 18 is a perspective view showing the operating apparatus in the non-regulating state in the second embodiment of the present invention;

FIG. 19 is a perspective view showing the regulating state of the operating apparatus shown in FIG. 18;

FIG. 20 is a plan view showing the moving member etc. viewed from the arrow XX direction in FIG. 18;

FIG. 21 is a sectional view showing the moving member etc. along XXI-XXI line in FIG: 18;

FIG. 22 is a plan view showing the moving member etc. viewed from the arrow XXII direction in FIG. 19;

FIG. 23 is a sectional view showing the moving member etc. along XXIII-XXIII line in FIG. 19;

FIG. 24 is a sectional view illustrating the state that the thick portion contacts to the convex portion when the regulating member of the operating apparatus of the present invention is formed with elastic material;

FIG. 25 is a plan view showing the regulating member and the thick portion shown in FIG. 24; and

FIG. 26 is a plan view showing the state that the operating axis is fallen to the convex portion of the regulating member and is rotated to contact to the convex portion.

### DETAILED DESCRIPTION OF THE PREFERRED EMBODIMENTS

The operating apparatus of the present invention is capable of switching a regulating state in which a regulating means regulates the swing direction of an operating axis, and a non-regulating state in which the regulating means does not regulate the swing direction of the operating axis and permits the operating axis to be positioned between detecting means adjacent to each other.

Thereby, it is enable to switch the regulating state in which the operating axis is regulated to be positioned between detecting means adjacent to each other and the permitting state in which the operating axis is allowed to be positioned between detecting means adjacent to each other.

Moreover, the regulating state may be in the state that when the operating axis is swung toward between the detecting means adjacent to each other, the operating axis is guided to either of the detecting means.

The regulating means may be provided with a regulating member having a convex portion. The switching means may be provided with a thick portion and thin portion provided in the operating axis and a moving means which moves at least one of the operating axis and the regulating means.

Moreover, in this invention, the operating axis is moved and the operating axis and the regulating member may be moved relatively.

Furthermore, the regulating member is moved and the operating axis and the regulating member may be moved relatively.

Moreover, the moving means is provided with a projected pin provided in either the movable moving member or the regulating member and an insertion bore provided in the other member, into which the projected pin enters, extending along the intersecting direction to the moving direction of the moving member and the longitudinal direction of the operating axis. The moving means changes suitably the position of the projected pin in the insertion bore by moving the moving member and may move the operating axis and the regulating member relatively by moving the regulating member. The regulating member may be formed with elastic material.

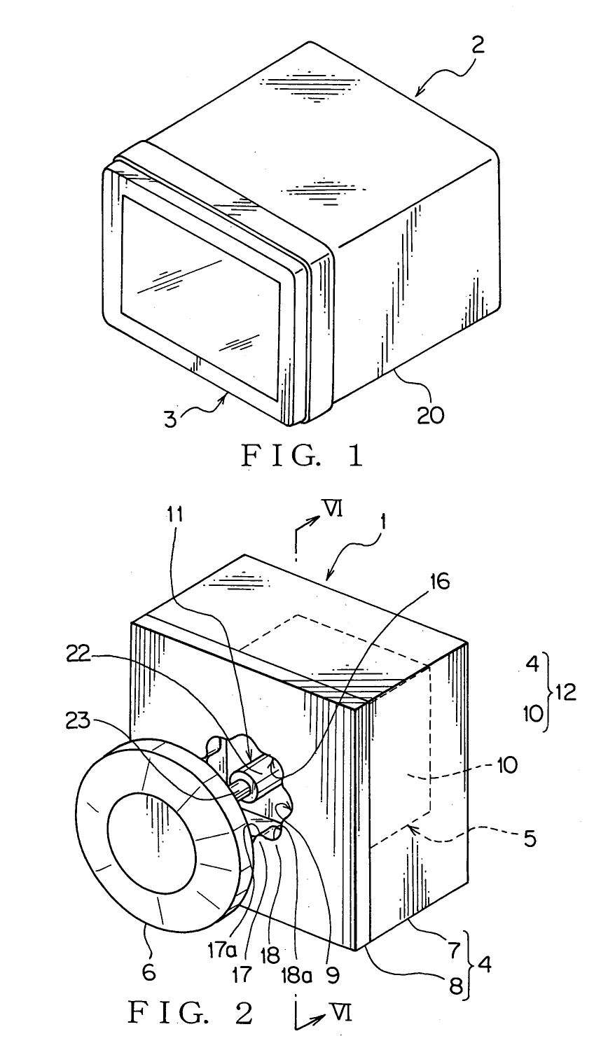

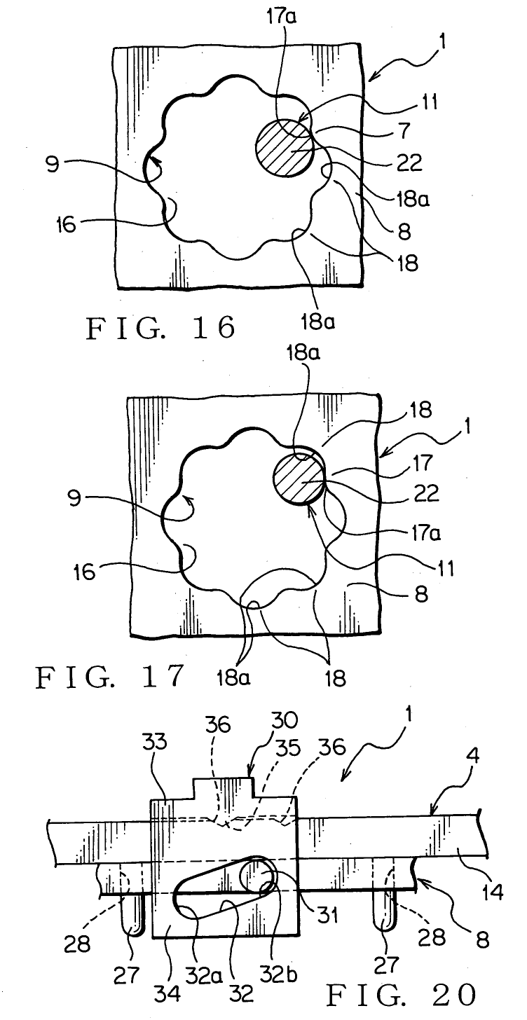

The operating apparatus of the first embodiment of the present invention is explained with reference to FIGS. 1 to 17. The operating apparatus 1 shown in FIG. 2 is attached to the navigating apparatus 2 shown in FIG. 1 which equipped to the instrument panel of a car as a movable body. Car navigation 2 is an electronic device described in this specification.

Car navigation 2 is provided with a main body 20 of apparatus and a display 3 as shown in FIG. 1. The main body 20 of the apparatus is formed in box-shape. The main body 20 of the apparatus processes the whole navigation system based on GPS positioning data etc. (Global Positioning System).

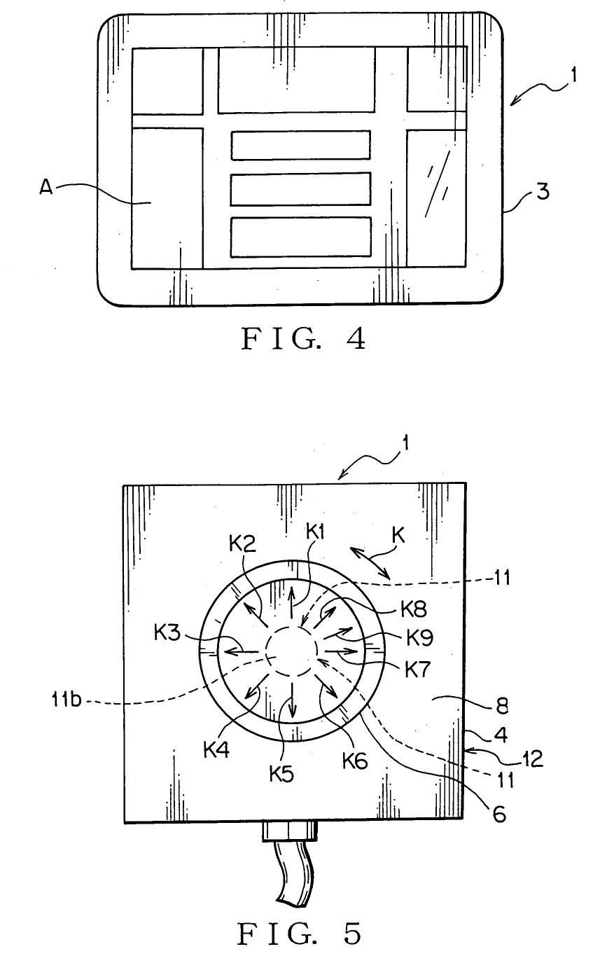

The display 3 is attached in the main body 20 of the apparatus. As shown in FIG. 4, the display 3 displays map data A or the characters, such as Japanese syllabary characters, and numbers which, not shown, are arranged in the shape of a lattice. The operating apparatus 1 moves the displayed area of the map data on the display 3 to a total of eight directions, such as upper, lower, left, right, or upper left direction.

The operating apparatus 1 moves the displayed area of the map data A to eight directions so as to display the wide range map data A which is over the range in the display 3 for displaying a whole at once.

Moreover, the operating apparatus 1 is used for moving the cursor in order to position the cursor on a desired character or a number of various kinds of characters and numbers on the display 3. The operating apparatus 1 positions the cursor on the desired character or number and chooses the character and number requested and inputs them to the main body 20 of the apparatus. The operating apparatus 1 chooses a character and a number, as mentioned above, for example, and it inputs the destination etc. into the main body 20 of the apparatus. Thus, the operating apparatus 1 is used for performing various kinds of operations of electronic devices, such as the car navigation 2.

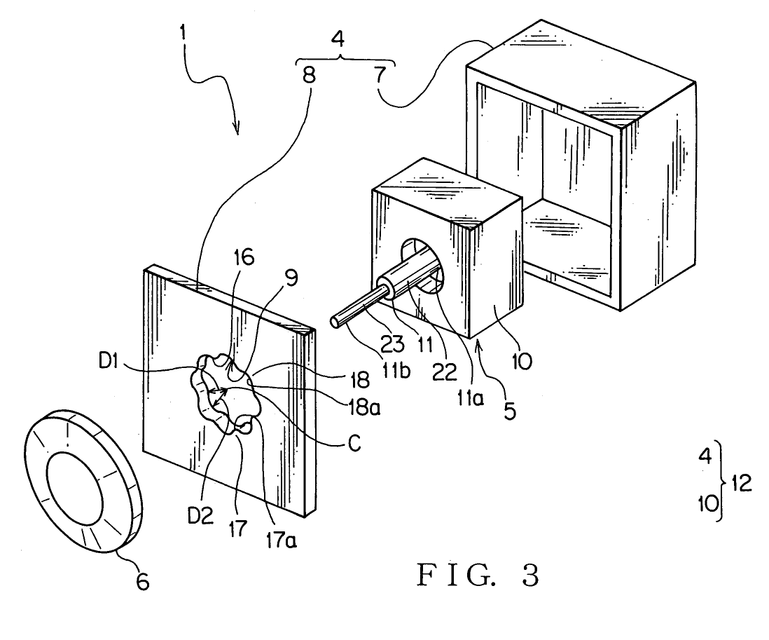

The operating apparatus 1, as shown in FIGS. 2 and 3, is provided with a cover 4, a joy stick 5, a knob 6, and a switching mechanism 21 as a switching means. The cover 4 is provided with a lower cover 7 of tube shape with a bottom and a regulating means. The lower cover 7 receives a supporting portion 10, as described below, of the joy stick 5.

The regulating means is provided with a plate-like regulating member 8. A through bore 9 is penetrated in the center of the regulating member 8. An operating axis 11 described below passes inside of the through bore 9. The detailed construction of the through bore 9 of the regulating member 8 will be described later. In the cover 4, the supporting portion 10 is received in the lower cover 7 and the operating axis 11 passes the through bore 9, and the lower cover 7 and the supporting portion 10 are fixed together. The lower cover 7 and the regulating member 8 are fixed together in the cover 4 inside which the supporting portion 10 of the joy stick is received.

The joy stick 5 is provided with the supporting portion 10 of box shape and a cylindrical operating axis 11 as shown in FIGS. 2 and 3. The supporting portion 10 is formed in the shape of a rectangular parallelepiped. The main body portion 12 comprises the supporting portion 10 and the cover 4.

The operating axis 11 is provided with a thick portion 22, a thin portion 23 and a locking portion 24 as shown in FIGS. 9 and 11. The thick portion 22, thin portion 23 and locking portion 24 are arranged concentrically and connected in series mutually. The locking portion 24 is provided in most one end portion 11a side of the operating axis 11 among the thick portion 22, thin portion 23 and locking portion 24. The locking portion 24 is locked at a moving portion 25 and attached to the moving portion 25. The thin portion 23 is provided in most the other end portion 11b side of the operating axis 11 among the thick portion 22, thin portion 23 and locking portion 24. The thick portion 22 is provided aside of the one end portion 11a side than the thin portion 23.

The one end portion 11a of the operating axis 11 is received in the supporting portion 10 and the other end portion 11b of the operating axis 11 is projected from the supporting portion 10. The other end portion 11b of the operating axis 11 is exposed out of the cover 4, i.e., the main body portion 12. The operating axis 11 is supported by the supporting portion 10 such that it can freely swing to many directions centered at the one end portion 11a. For this reason, the operating axis 11 is supported in the main body portion 12 and can swing freely to many directions centered at the one end portion 11a.

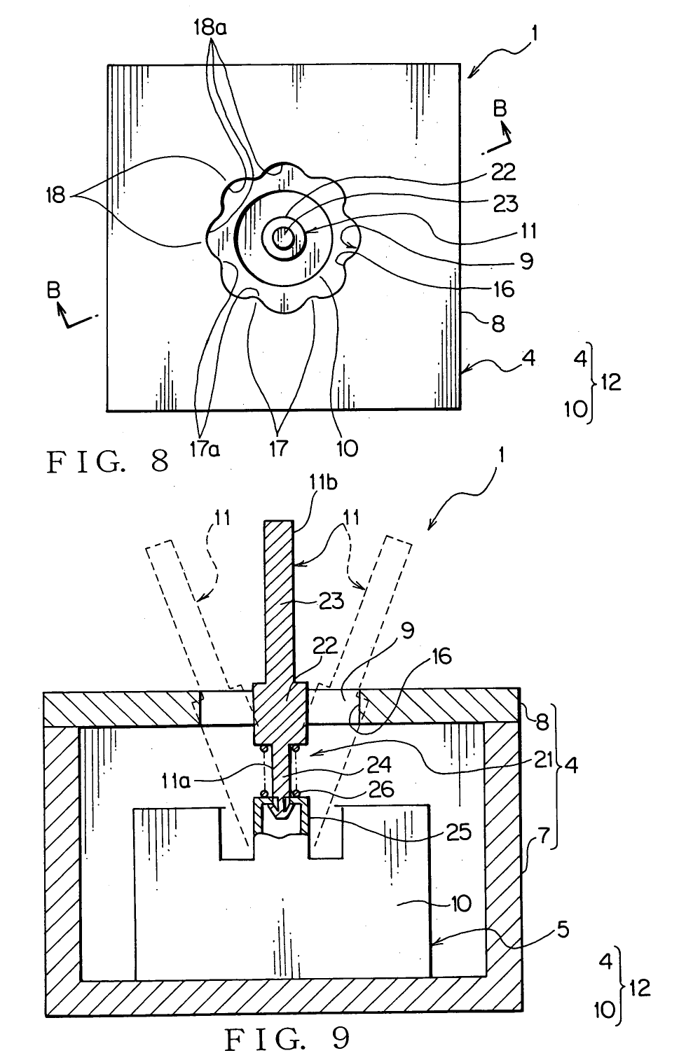

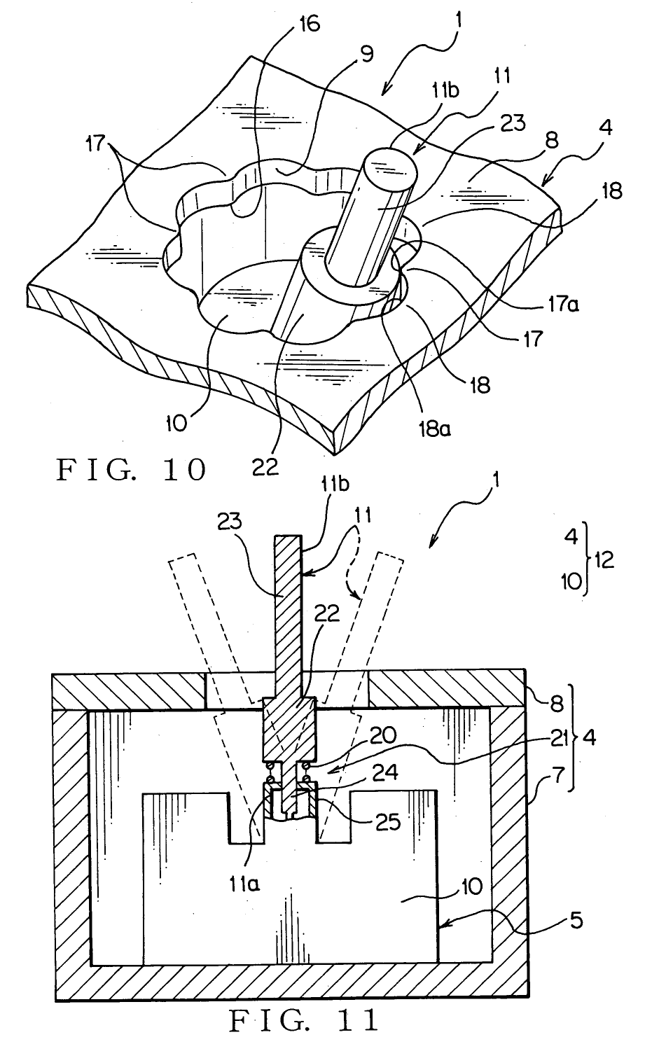

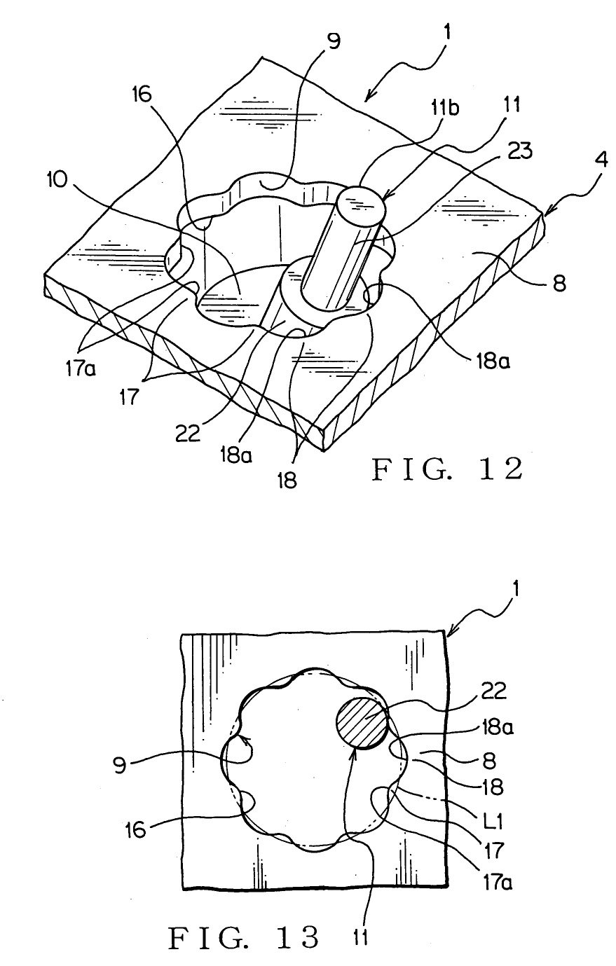

For this reason, the operating axis 11 can swing freely along the arrow from K1 to K8 in FIG. 8 centered at the one end portion 11a against the supporting portion 10. The operating axis 11 swings to the supporting portion 10 centered at the one end portion 11a as shown in FIGS. 10 and 12 and falls down to the supporting portion 10 and can rotate freely along with the arrow K in FIG. 5. Furthermore, the operating axis 11 can freely swing to any directions among the arrows from K1 to K8 for the supporting portion 10, centered at the one end portion 11a.

Moreover, an urging means, not shown, urges the operating axis 11 being in the perpendicular direction to the top surface of the supporting portion 10, shown in FIGS. 9 and 11. When the longitudinal direction, shown as a solid line in FIGS. 9 and 11, being perpendicular to the top surface of the supporting portion 10, it is in the state that the operating axis 11 does not fall (or swing) to the supporting portion 10. At the neutral position, the position of the operating axis 11 and a knob 6 shown as a solid line in FIGS. 9 and 11 is referred to neutral position hereafter. Moreover, in the neutral position, the one end portion 11a of the operating axis 11 touches neither of the detecting switches 13.

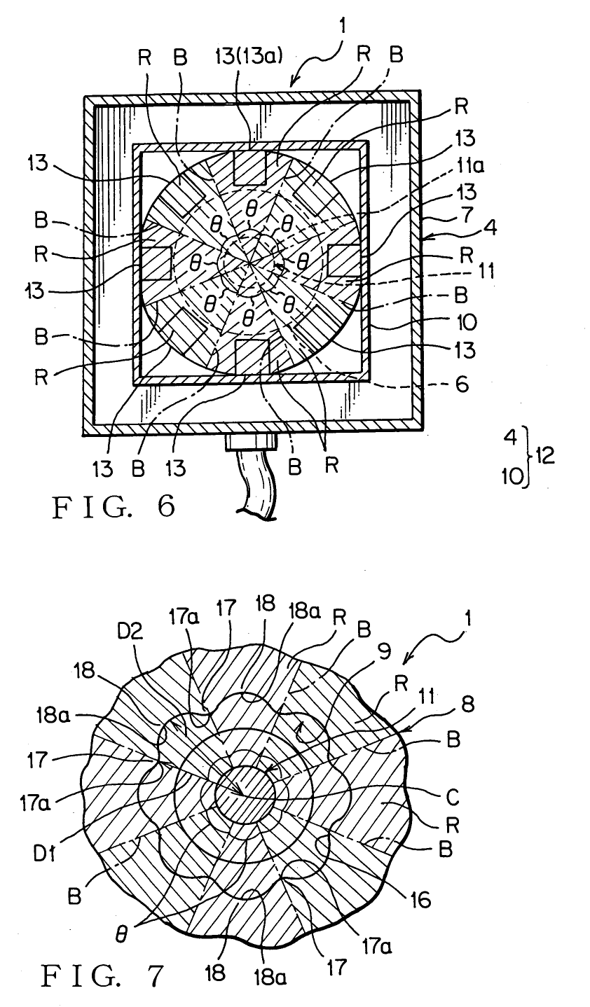

Moreover, a plurality of detecting switches 13 are provided in the supporting portion 10, as shown in FIG. 6, as detecting means. For this reason, the operating apparatus 1 is provided with a plurality of detecting switches 13. The detecting switch 13 is arranged in at equal intervals along the direction of a circumference centered at the one end portion 11a of the operating axis 11, as shown in FIG. 6. The operating axis 11 swings to the supporting portion 10 and the one end portion 11a thereof enters in the detecting area R shown with an parallel slash in FIG. 6 and contacts to the detecting switch 13. The detecting switch 13 detects the swing of the operating axis 11 by the contact with the one end portion 11a.

Thus, when the one end portion 11a of the operating axis 11 accesses, the detecting switch 13 detects that the one end portion 11a contacts. If the detecting switch 13 detects that the one end portion 11a of the operating axis 11 contacts, i.e., detects that the one end portion 11a of the operating axis 11 enters in the detecting area R, it will output the information thereof toward the main body 20 of the apparatus, i.e., car navigation 2. The main body 20 of the apparatus moves the map information A or the cursor according to the detecting switch 13 which outputs the information mentioned above. When the one end portion 11a of the operating axis 11 contacts the detecting switch 13 (referred to as numeral 13a hereafter) located uppermost in FIG. 6, the display 3 moves the map information A or cursor to the upper direction in FIG. 4.

Moreover, the detecting area R of each detecting switch 13 is formed in the sector in which the operating axis 11, i.e., the one end portion 11a is the center of the circular arc. Eight detecting switches 13 are provided in the example of illustration and the central angle e of the detecting area R of each detecting switch 13 is 45 degrees.

A plurality of detecting areas R are arranged without interval and overlapping mutually. For this reason, when the operating axis 11 swings from a neutral position to the supporting portion 10, the detecting switch detects that the one end portion 11a of the operating axis 11 contacts any one detecting switch 13 among a plurality of detecting switches 13. Moreover, a boundary B shown by dashed line in FIG. 6 is formed between adjacent detecting area R. The boundary B is provided, in each adjacent detecting area R. These boundaries extend radially from the center core of the operating axis 11, i.e., the one end portion 11a.

The knob 6, as shown in FIGS. 2 and 3, is formed in the shape of a disk and is attached in the other end portion 11b of the operating axis 11. The outer diameter of the knob 6 is fully larger than that of the operating axis 11. Moreover, the knob 6 is attached in the operating axis 11 coaxially.

The through bore 9 provided in the center of the regulating member 8 extends through the regulating member 8. The regulating member 8 is attached to the under cover 7 with the operating axis 11 through the through bore 9. The through bore 9 is coaxial with the operating axis 11 of neutral position.

The inner edge 16 of the insertion bore is provided with convex portion 17 and concave portion 18 alternately as shown in FIGS. 7 and 8. The inner edge 16 of the through bore 9 is formed in convexo-concave. The convex portion 17 of the inner edge 16 is formed in convex directing to the center C of the through bore 9. The concave portion 18 of the inner edge 16 is formed in concave departing from the center C of the through bore 9. The convex portion is arranged nearly to the center C of the through bore 9 than the concave 18. The concave 18 is more apart from the center C of the through bore 9 than the convex 17.

Moreover, the top portion 17a which is most close to the center C of the through bore 9 of the convex portion 17 is lined to the boundary B along the longitudinal direction of the operating axis of neutral position as shown in FIG. 7. When the top portion 17a is lined with the boundary B along the longitudinal direction of the operating axis 11 of neutral position, it is stated that it locates on or corresponds to the boundary B in this specification. That is, the convex portion 17 is provided above the boundary B. The convex 17 corresponds to the boundary B, i.e., between the detecting switches 13 adjacent to each other. The bottom portion 18a of the concave 18, departing most from the center C of the through bore 9, is arranged to be lined with the center of the adjacent boundary B each other (between the boundary B) along the longitudinal direction of the operating axis 11 of neutral position. When the bottom portion 18a is lined between the boundary B, i.e., the detecting area R along the longitudinal direction of the operating axis 11 of neutral position, it is stated that it locates above or corresponds to between the boundary B, i.e., the detecting area R in this specification. The concave portion 18 is formed above between the boundaries B adjacent to each other. That is, the concave portion 18 corresponds to each of the detecting switch 13.

For this reason, the distance D1 from the center C of the through bore 9 to the top portion 17a, which positions above the boundary B, of the convex 17 in the inner edge 16 of the through bore 9 is shorter than the distance D2 from the center C of the through bore 9 to the bottom portion 18a, which positions above between the boundary, of the concave 18, as shown in FIG. 7. The inner edge 16 of the through bore 9 is formed in curved surface over the convex portion 17 and concave portion 18. The convex portion 17 abuts to the operating axis 11 swung at the regulating state described below. Thereby the regulating member 8 regulates the swing direction of the operating axis 11.

The switching mechanism 21, as shown in FIGS. 9 and 11, comprises the thin portion 23 provided in the operating axis 11, the thick portion 22 provided in the operating axis 11, the moving portion as for movable means, and a coil spring 26 as for urging means. The thin portion 23 is provided in the other end portion 11b of the operating axis 11. The thick portion 22 is provided in more the one end portion 11a side of the operating axis 11 than the thin portion 23. The thick portion 22 is communicated with the thin portion 23 and thicker than the thin portion 23. For this reason, the thin portion 23 and thick portion 22 are provided to be in communication with along the longitudinal direction of the operating axis 11.

The moving portion 25 is provided in the supporting portion 10 of the joy stick 5 as shown in FIGS. 9 and 11. The locking portion 24 locks to the moving portion 25 and the one end portion 11a of the operating axis 11 is attached to the moving portion. The locking portion 24 locks and then the moving portion 25. supports the one end portion 11a of the operating axis 11, i.e., the thick portion 22 for swinging freely to many directions between the positions shown as dotted line in FIGS. 9 and 11 centered at the one end portion 11a.

The moving portion 25 supports movably the thick portion 22, i.e., the operating axis 11 along the longitudinal direction of the operating axis 11. The moving portion 25 supports movably the thick portion, i.e., the operating axis 11 and at least one of the operating axis 11 and the regulating member 8 is movable along the longitudinal direction of the operating axis 11.

The coil spring 26 inside which the locking portion 24 of the operating axis 11 passes, is provided between the moving portion 25 and the thick portion 22 of the operating axis 11. The coil spring 26 urges the thick portion 22, i.e. the operating axis 11 to the direction in which the thick portion 22 departs from the moving portion 25, i.e., the operating axis 11 departs from the supporting portion 10.

The switching mechanism 21 moves the operating axis 11 freely during the regulating state shown in FIGS. 9 and 10, and the non-regulating state shown in FIGS. 11 and 12 where the coil spring 26 urges the thick portion 22 and the moving portion 25 supports movably the operating axis 11. The operating axis 11 is most protruded from the supporting portion 10, i.e., the main body portion 12 at the regulating state due to the urging force of the coil spring 26.

At the regulating state, the thick portion 22 of the operating axis 11 is opposed to the inner edge 16, i.e., the convex portion 17 of the through bore 9, as shown in FIG. 9. This is meant in this specification that the thick portion 22 and the convex portion 17 is positioned by the moving portion 25. At the regulating state, when the operating axis 11 is fallen down (swing) to the supporting portion 10 and is rotated along the arrow K, the trajectory L1 (indicated by a chain double-dashed line in FIG. 13) of the thick portion 22 of the operating axis 11 on the surface of the regulating member 8 interferes with the convex 17 of the through bore 9. Then, at the regulating state, the operating axis 11 is fallen down (swing) to the supporting portion 10, i.e., the main body portion 12 and the thick portion 22 contacts to the convex 17 of the through bore 9.

For this reason, at the regulating state, the thick portion 22 of the operating axis 11 contacts, to the convex 17 to fall down (swing) to the supporting portion 10, i.e., the main body portion 12, and the operating axis 11 is regulated by the convex 17, namely the regulating member 8 such that it does not position on the boundary B, i.e., between the detecting switches 13 adjacent to each other. At the regulating state, the thick portion 22 contacts to the convex portion 17 to fall down (swing) to the supporting portion 10, i.e., the main body portion 12, the operating axis 11 is guided by the convex 17, i.e., the regulating member 8 such that the one end portion 11a contacts to one of the detecting areas R adjacent to each other from the boundary B, i.e., between the detecting switches 13 adjacent to each other. In this way, at the regulating state, the swing direction of the operating axis 11 is regulated. At the regulating state, when the operating axis 11 is swung directed to between the detecting switches 13 adjacent to each other, it is guided to one of the detecting switches 13.

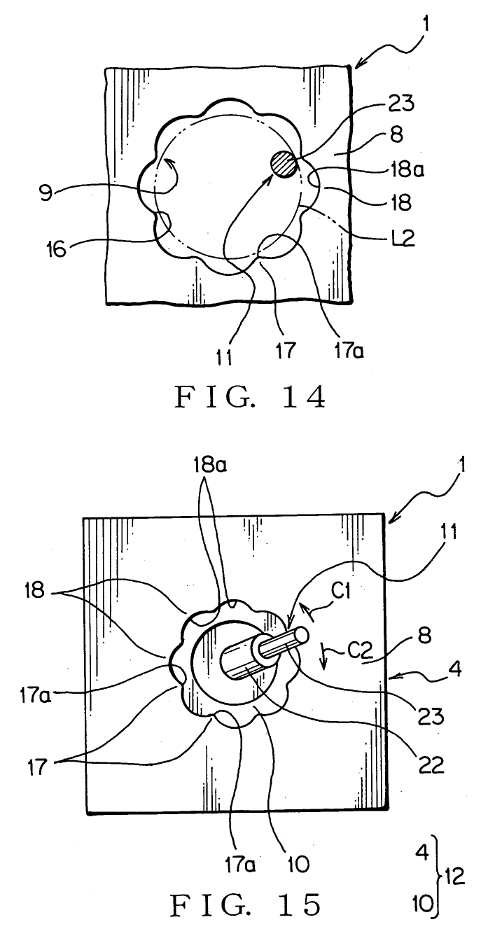

At the non-regulating state, the operating axis 11 resists for the abutting force of the coil spring 26 and accesses to the supporting portion 10 from the regulating state as show in FIG. 11. At the non-regulating state, the thin portion 23 of the operating axis 11 opposes to the inner edge 16, i.e., the concave 18 of the through bore 9 along the radial direction of the through bore 9. It is indicated in this specification that the thin portion 23 and the convex portion 17 are positioned by the moving portion 25. At the non-regulating state, when the operating axis 11 is fallen down (swung) to the supporting portion 10 and is rotated along the arrow K, the trajectory L2 (a chain double-dashed line shown in FIG. 14) of the thin portion 23 of the operating axis 11 on the surface of the regulating member does not interfere with the convex 17 of the through bore 9 and has a clearance from the convex 17.

For this reason, at the non-regulating state, the operating axis 11 is fallen down (swung) to the supporting portion 10, i.e., the main body portion 12 but does not contact with the convex 17 of the through bore 9.

At the non-regulating state, when the thin portion 23 is separated from the convex 17 and fallen down (swung) to the supporting portion 10, i.e., the main body portion 12, the operating axis 11 is allowed to be positioned on the boundary B, i.e., between the detecting switches 13 adjacent to each other. By this, at the non-regulating state, the swing direction of the operating axis 11 is not regulated.

The switching mechanism 21 is capable of switching the regulating state to guide the operating axis 11 such that the regulating member enters into at least one of the detecting areas R adjacent to each other and the non-regulating state to allow the operating axis 11 positioning over the boundary B. The operating apparatus 1 becomes the non-regulating state when the thin portion 23 is positioned to the convex 17 and the regulating state when the thick portion 22 is positioned to the convex 17, by the moving portion.

The operating axis 11 is passed through the coil spring 26 and the locking portion 24 thereof is locked at the moving portion 25 of the supporting portion 10 in the operating apparatus 1. Then the joy stick 5 is constructed. The supporting portion 10 is received in the under cover 7 and the operating axis 11 is through the through bore 9 and the under cover 7 and the regulating member 8 is fixed each other. The other end portion 11b of the operating axis 11 is attached to the knob 6.

When the car navigation 2 is operated, i.e., the map data A on the display 3 is moved by using the operating apparatus 1, for example, the operating axis 11 is depressed to the supporting portion 10, i.e., the main body portion 12 resisting the abutting force of the coil spring 26 so as to be in the non-regulating state. The thin portion 23 is positioned to the convex portion 17. At this non-regulating state, the operating axis 11 can be fallen to the directions to move. Then the detecting switch 13, which corresponds to the falling down direction of the operating axis 11, detects the one end portion 11a of the operating axis 11 to contact and the map data A on the display 3 moves to the direction of the falling down direction of the operating axis 11.

For example, when moving the map data A displayed upward in FIG. 6, the one end portion 11b of the operating axis 11, i.e., the knob 6 is moved (fallen down) upwardly in FIG. 5 along the arrow K1 in FIG. 5. The one end portion 11a of the operating axis 11 contacts to the detecting switch 13a which positions most upper in FIG. 6 and the information thereof is output to the car navigation 2, namely the display 3. Then, the map data A on the display 3 is moved to upper.

When displaying the characters and numbers on the display 3, choosing the desired characters and numbers therefrom and inputting them to the main body 20 of the apparatus 20, for example, the operating axis 11 is maintained in the regulating state. The thick portion 22 is positioned to the convex 17 and at the regulating state, the cursor is fallen down to the direction to move. The detecting switch 13 which corresponds to the falling direction of the operating axis 11, detects the one end portion 11a of the operating axis 11 to contact to it and the cursor on the display 3 is moved to the direction which corresponds to the falling direction of the operating axis 11.

At this time, for example, the operating axis 11 is fallen down (swung) to along the arrow K9 in the center of between the arrow K7 and K8 in FIG. 5 and the thick portion 22 of the operating axis 11 contacts to the convex 17 of the inner edge 16 of the through bore 9 of the regulating member 8. That is, the operating axis 11 fallen down (swung) positions to the boundary B, namely between the detecting switches 13 adjacent to each other.

Then the convex portion 17 and the thick portion 22 interferes each other and the knob 6, i.e., the operating axis 11 moves to the arrow C1 or arrow C2 direction in FIG. 15. The operating axis 11 enters into the concave 18 and the knob 6, i.e., the operating axis moves. For example, when the operating axis 11 moves to the arrow C1 direction in FIG. 15, it is positioned as shown in FIG. 17. Then, the one end portion 11a contacts to the detecting switch 13 which corresponds to the falling down position of the operating axis 11 and the cursor on the display 3 moves.

At the regulating state, when the one end portion 11a of the operating axis 11 positions to the boundary B of the detecting area R of the detecting switches 13 adjacent to each other, the inner edge 16 of the through bore 9 of the regulating member 8 guides the operating axis 11 the one end portion 11a of which contacts to any one of the detecting areas R of the detecting switches adjacent to each other. The operating axis is thus guided. At the regulating state, the detecting switch 13 which corresponds to the direction to which the cursor moves, detects assuredly the one end portion 11a of the operating axis 11.

According to the present embodiment, the switching mechanism 21 is capable of switching the regulating state in which the regulating member 8 regulates the swing direction of the operating axis 11 such that the one end portion 11a 8 contacts to any detecting switch 13 and the non-regulating state in which the operating axis 11 is allowed to position between the detecting switches 13 adjacent to each other and the swing direction of the operating axis 11 is not regulated. Therefore, it is able to switch assuredly the state of regulating the operating axis 11 to position to between the detecting switches 13 adjacent to each other and the state of allowing the operating axis 11 to position to between the detecting switches 13 adjacent to each other.

The regulating member 8 has the through bore 9 the inner edge 16 of which is formed in convexo-concave shape. The switching mechanism 21 is provided with the thick portion 22 provided in the operating axis 11, the thin portion 23 and the moving portion 25 to move the operating axis 11.

The thick portion 22 contacts to the convex portion 17 of the through bore 9 at the regulating state. Thereby, at the regulating state, the thick portion 22 contacts to the convex portion 17 of the through bore 9 so that the operating axis 11 is guided for the thick portion 22 to enter into the concave portion 18. The convex portion 17 positions to between the detecting switches adjacent to each other and the concave portion 18 positions to the detecting switch 13. Therefore, at the regulating state, the operating axis 11 is guided for the one end portion 11a to contact between the boundarys B, i.e., any one of the detecting switches 13 adjacent to each other.

The thin portion 23 opposes to the convex 17 of the through bore 9 with a clearance at the non-regulating state. Therefore, at the non-regulating state, the operating axis 11 does not interfere with the inner edge 16 of the through bore 9 and positions to between the detecting switches 13 adjacent to each other but also positions to any detecting switch 13.

Thus, the inner edge 16 of the through bore 9 of the regulating member 8 is formed in convexo-concave shape and the operating axis 11 is provided with the thick portion 22 and the thin portion 23 so as to make the operating axis 11 movably by the moving portion 25.

By doing so, it is possible to switch assuredly the state of regulating the operating axis 11 to be positioned to above the boundary B of the detecting area R of a plurality of the detecting switches 13 and the state of allowing the operating axis 11 to be positioned to above the boundary B.

The inner edge 16 of the through bore 9 of the regulating member 8 is formed in curved surface. Therefore the operating axis 11 can be smoothly rotated particularly at such state that the operating axis 11 is fallen down at the regulating state.

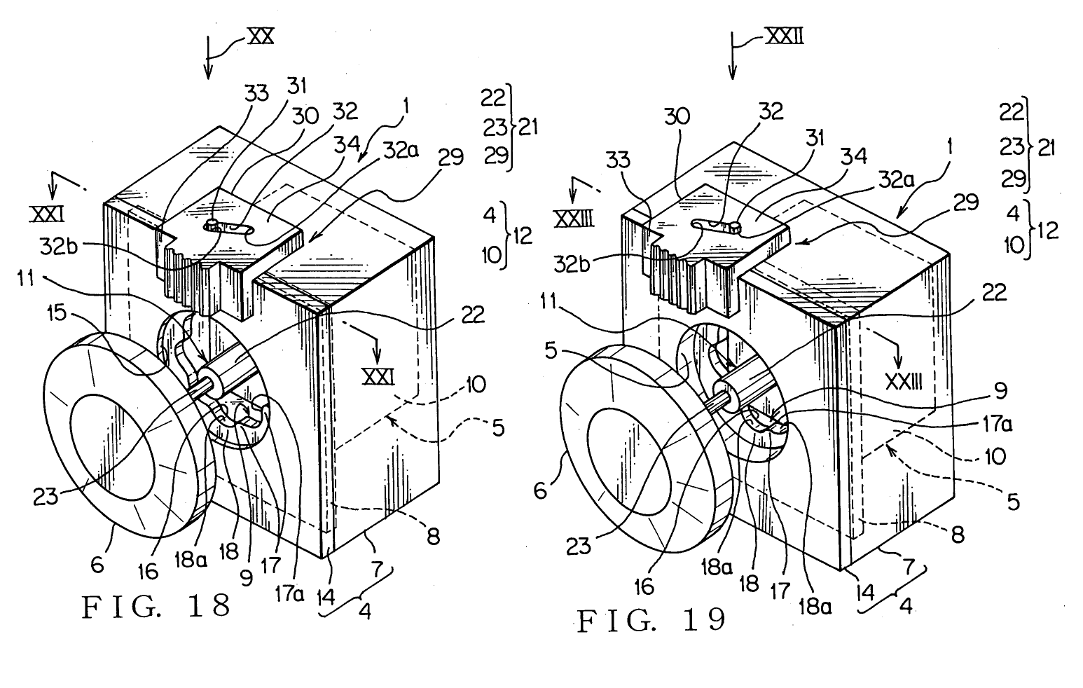

The second embodiment of the present invention is illustrated referring to FIGS. 18 to 23. In this embodiment as shown in FIGS. 18 and 19, the cover 4 constitutes the under cover 7 and the upper cover 14 attached to the under cover 7 and the regulating member is received in the cover 4. The upper cover 14 and the regulating member 8 constitute the main body portion 12.

The upper cover 14 is formed in tabular shape and the operating axis 11 extends through at the center of the bore 15. The bore 15, formed in circular shape, is larger than the through bore 9. The bore 15 is arranged concentrically with the operating axis 11 of the neutral position and the through bore 9. The upper cover 14 and the regulating member 8 are interposed. The upper cover 14 is provided with the guiding rod 27 shown in FIGS. 20 to 23 and the regulating member 8 is provided with the guiding bore 28 for the insertion of the guiding rod 27. The guiding rod 27 is inserted into the guiding bore 28 and is movable inside the guiding bore 28.

For this reason, the guiding rod 27 moves inside the guiding bore 28 and the regulating member 8 stands off and on the upper cover 14. The regulating member 8 stands off and on the upper cover 14 so that it is movable along the longitudinal direction of the operating axis 11 of the neutral position.

Further, in this embodiment, the operating axis 11 is supported at the supporting portion 10 along the longitudinal direction so that the operating axis 11 does not move.

Furthermore, the switching mechanism 21 of the operating apparatus 1 of the present embodiment is, provided with the moving mechanism 29 for moving means besides the thick portion 22 and the thin portion 23. The moving mechanism 29 is provided with the moving member 30, the projected pin 31, and the insertion bore 32 as shown in FIGS. 18 to 23.

The moving member 30 is supported movably along the surface of the upper cover 14 of the cover 4, i.e. the main body portion 12. The moving member 30 is provided movably along the direction perpendicular (intersecting) to the longitudinal direction of the operating axis 11 of the neutral position. The moving member 30 is provided in one with the upper cover superimposed portion 33 of tabular shape superimposed on the surface of the upper cover 14 and the under cover superimposed portion 34 of tabular shape communicated with the upper cover superimposed portion 33 and superimposed to the side wall of the under cover 7. The surface of the upper cover superimposed portion 33 and the surface of the under cover superimposed portion 34 are intersecting (perpendicular) to each other.

The projected pin 31 is formed in a rod shape extending outwardly the main body portion 12 from the outer edge of the, regulating member 8. The projected pin 31 is protruded outwardly of the cover 4. The insertion bore 32 penetrates the under cover superimposed portion 30 of the moving member 30. The insertion bore 32 is formed in elongated bore shape. The longitudinal direction of the insertion bore 32 extends to along the direction intersecting both with the longitudinal direction of the operating axis 11 of the neutral position and the moving direction of the surface of the upper cover 14, i.e., the moving member 30. The projected pin 31 enters into the insertion bore 32. The projected pin 31 inside the insertion bore 32 is movable along the longitudinal direction of the insertion bore 32.

The moving member 30 moves along the surface of the upper cover 14 so that the projected pin 31 moves between the one end portion 32a close to the one end potion 11a of the operating axis 11 of the insertion bore 32 shown in FIG. 19 and the other end portion 32b close to the other end portion 11b of the operating axis 11 of the insertion bore 32 shown in FIG. 18. The projected pin 31 moves inside the insertion bore 32 and the regulating member 8 approaches to and departs from the upper cover 14. That is, the projected pin 31 moves inside the insertion bore 32 and the regulating member 8 moves along the longitudinal direction of the operating axis 11 of the neutral position.

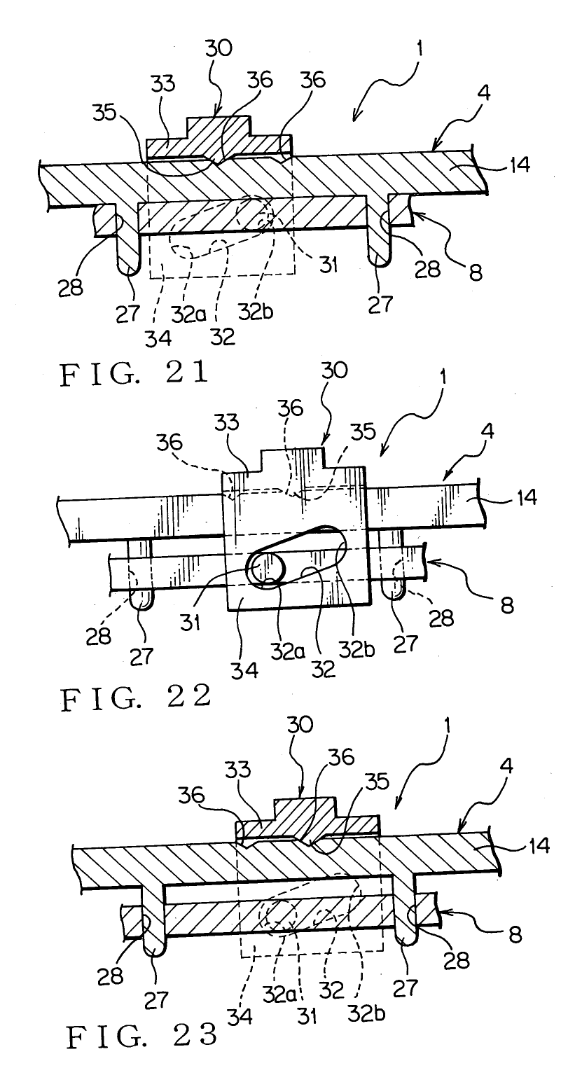

When the projected pin 31 positions in the other end portion 32 of the insertion bore 32, the regulating member 8 approaches to the upper cover 14 and overlaps to the upper cover 14 without clearance as shown in FIGS. 20 and 21. It is the non-regulating state that the regulating member 8 overlaps to the upper cover 14 without clearance as shown in FIGS. 18, 20 and 21. When the projected pin 31 positions in the one end portion 32a of the insertion bore 32, the regulating member 8 departs from the upper cover 14 and makes clearance as shown in FIGS. 22 and 23. It is the regulating state that the regulating member has a clearance for the upper cover 14 as shown in FIGS. 19, 22 and 23.

The moving mechanism 29 moves the moving member 30 against the main body portion 12 and changes the position of the projected pin 31 inside the insertion bore 32 so that it moves the regulating member 8 along the longitudinal direction of the operating axis 11. The moving mechanism supports movably the regulating member 8 so that at least one of the operating axis 11 and the regulating member 8 becomes movable along the longitudinal direction of the operating axis 11.

The moving mechanism 29, i.e., the switching mechanism 21 moves the moving member 30 against the main body portion 12 so that it switches the regulating state and the non-regulating state. In the present embodiment, at the regulating state, the thick portion 22 of the operating axis 11 interferes (contacts) with the convex 17 of the through bore 9. At the non-regulating state, the thin portion 23 of the operating axis 11 does not interfere (contact) with the convex 17 of the through bore 9 and makes a clearance for the convex 17.

Furthermore, in the present embodiment, in order to give a click sense to users when moving the moving member 30, the moving member 30 is provided with a convex projection 35 toward the upper cover 14 and the upper cover 14 is provided with a pair of the concave 36 to lock the projection 35.

The projection 35 locks in one of the pair of the concaves 36 so that the regulating member 30 is maintained in the regulating or non-regulating state. The projection 35 locking in one concave exits from it and locks in the other so that the regulating member 30 moves between the regulating state and the non-regulating state. When the projection 35 exiting from the concave 36 and entering the concave 36, the moving member 30 and the upper cover 14 are deformed elastically. The elastic resilience produced by the elastic deformation causes a click sense.

In this embodiment as well as the first embodiment, when moving the display area of map data A on the display 3, the moving mechanism 29 is held in the non-regulating state shown in FIGS. 18, 20 and 21 and the operating axis 11 is fallen down to the desired direction. When moving the cursor on the desired characters and numbers on the display 3, the moving member 29 is held in the regulating state shown in FIGS. 19, 22 and 23 and the operating axis 11 is fallen down to the desired direction.

In the second embodiment, the upper cover 14 is provided with the guiding rod 27 and the regulating member 8 is provided with the guiding bore 28. However, the upper cover 14 is provided with the guiding bore 28 and the regulating member 8 may be provided with the guiding rod 27 at the present invention. At the present invention, in short, the guiding rod 27, which is parallel to the longitudinal direction of the operating axis 11 of the neutral position, is provided in either one of the upper cover 14, i.e., the main body portion 12 and the regulating member 8., and the guiding bore 28, into which the guiding rod 27 enters and swing (moves) freely, is provided in the other in order to make the regulating member 8 movably to the upper cover, i.e., the main body portion 12.

In the second embodiment, the regulating member 8 is provided with the projected pin 31 and the moving member 30 is provided with the insertion bore 32. However, at the present invention, the regulating member 8 is provided with the insertion bore 32 and the moving member 30 may be provided with the projected pin 31. At the present invention, in short, the projected pin 31, which is intersecting (perpendicular) to the longitudinal direction of the operating axis 11 of the neutral position, is provided in either one of the regulating member 8 and the moving member 30, and the insertion bore 32, into which the projected pin 31 enters and swing (moves) freely, is provided in the other in order to make the regulating member 8 movably to the upper cover, i.e., the main body portion 12.

Moreover, in the second embodiment, the moving member 30 is provided with the projection 35 and the upper cover 14, i.e., the main body portion 12 is provided with the concave 36. However, at the present invention, the regulating member 30 is provided with the concave 36 and the upper cover 14, i.e., the main body portion 12 may be provided with the projection 35. At the present invention, in short, the projection 35 of the convex is provided in either one of the moving member 30 and the upper cover 14, i.e., the main body portion 12 and faces toward the other. The concave 36 is provided in the other for the projection 36 to lock in order to provide a click sense to users when moving the moving member 30.

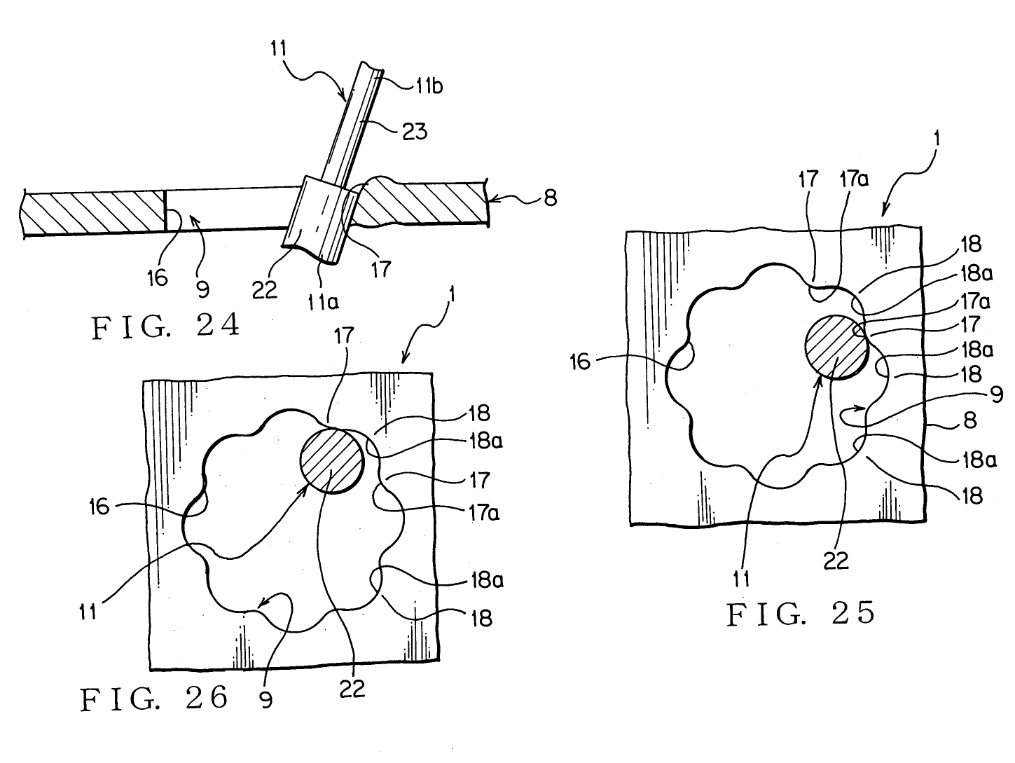

In the first and second embodiments, the regulating member 8 may constitute elastic material, such as rubber. In this case, at the regulating state, the operating axis 11 is fallen down along the arrow K9 from the neutral position. As the operating axis 11 is fallen down, i.e., inclines to the supporting portion 10, the convex portion 17 contacts to the thick portion 22 and the convex portion 17 of the regulating member 8 is elastically deformed to the direction apart from the center C of the through bore 9 as shown in FIGS. 24 and 25. Due to the elastic resilience of the regulating member 8, when the operating axis 11 is fallen down to, i.e., the knob 6 is pressed to the regulating member 8, the operating axis 11 is guided for the one end portion 11a to enter into any of the detecting area R.

Moreover, at the regulating state, the operating axis 11 is fallen down to the supporting portion 10 from the neutral position and enters into the concave portion 18 and in such the state there is rotated the operating axis 11 along the arrow K in FIG. 11 centered at the supporting portion 10. The thick portion 22 of the operating axis 11 contacts to the convex 17 of the inner edge 16 of the insertion bore 9 and the convex portion 17 is pressed by the operating axis 11 and elastically deformed to the direction apart from the center C of the insertion bore 9. Then the operating axis 11 is fallen down to the supporting portion 10 and in such the state is rotated centering at the supporting portion 10.

In this case, since the regulating member 8 consists of elastic material, when the thick portion 22 of the operating axis 11 contacts to the convex 17 at the regulating state, the convex portion 17 elastically is deformed to the direction apart from the center C of the through bore 9. The operating axis 11 is guided into the concave 18 due to the elastic resilient of the elastic deformation.

The regulating member 8 consists of elastic material so that the regulating member 8 assuredly guide the one end portion 11a of the operating axis 11 to enter into any detecting area R of the detecting switches adjacent to each other.

In the first embodiment, the operating axis 11 is moved and in the second embodiment, the regulating member 8 is moved. However, in the present invention, both the operating axis 11 and the regulating member 8 may be moved. In the present invention, at least one of the operating axis 11 and the regulating member 8 can be moved.

In the first and second embodiments, the operating apparatus 1 is utilized for the operation of car navigation 2. However, the operating apparatus 1 may be used for several operations of several electronic devices such as well known game apparatus.

The invention may be embodied in other specific forms without departing from the spirit or essential characteristics thereof. The present embodiment is therefore to be considered in all respects as illustrative and not restrictive.

1. An operating apparatus comprising; an operating axis swinging freely to many directions centered at an one end portion;
a plurality of detecting means provided in the circumferential direction centered at the one end portion of the operating axis whereby the detecting means detect the operating axis to swing;
an regulating means to regulate the swing direction of the operating axis; and
a switching means capable of switching a regulating state which regulates the swing direction of the operating axis and a non-regulating state which does not regulate with the regulating means.

2. The operating apparatus described in claim 1, characterized in that the regulating state is that when the operating axis swings to between the detecting means adjacent to each other the operating axis is guided to either one of the detecting switches.

3. The operating apparatus described in claim 1, characterized in that the regulating means is provided with a regulating member having a convex which rebuts to the operating axis swung and regulates the swing direction thereof, the switching means is provided with a thin portion and a thick portion provided in the operating axis in communication with along the longitudinal direction of the operating axis and a moving means which moves freely at least one of the operating axis and the regulating member to the longitudinal direction, and switches the non-regulating state in which the thin portion and the convex portion are positioned and the regulating state in which the thick portion and the convex portion are positioned by the moving means.

4. The operating apparatus described in claim 3, characterized in that the moving means is provided with a moving member which is movable along the direction intersecting to the longitudinal direction of the operating axis, a projected pin provided in either one of the regulating member and the moving member projecting from one member to the other member and a insertion bore which is provided in the other member, into which the projected pin enters, extending along the intersecting direction to both of the moving direction of the moving member and the longitudinal direction of the operating axis, the moving member being moved to change the position of the projected pin inside the insertion bore whereby to move the regulating member to along the longitudinal direction of the operating axis.

5. The operating apparatus described in claim 2, characterized in that the regulating member is formed with elastic material.
